(19) United States
(12) Patent Application Publication
(10) Pub. No.: US 2023/0110500 A1
(43) Pub. Date: Apr. 13, 2023

(54) Electrode Assembly and Battery Cell Including the Same

(71) Applicant: LG Energy Solution, Ltd., Seoul (KR)

(72) Inventors: Seong Won Choi, Daejeon (KR); Su Taek Jung, Daejeon (KR); Hyeok Jeong, Daejeon (KR); Soon Kwan Kwon, Daejeon (KR); Sangho Bae, Daejeon (KR); Yong Jun Lee, Daejeon (KR)

(73) Assignee: LG Energy Solution, Ltd., Seoul (KR)

(21) Appl. No.: 17/952,921

(22) Filed: Sep. 26, 2022

(30) Foreign Application Priority Data
Sep. 27, 2021 (KR) 10-2021-0127163
Sep. 8, 2022 (KR) 10-2022-0114320

(51) Int. Cl. H01M 10/0585; H01M 50/466; H01M 50/531; H01M 10/04

(52) U.S. Cl. CPC H01M 10/0585; H01M 10/0459; H01M 50/466; H01M 50/531

(57) ABSTRACT

An electrode assembly includes a plurality of electrodes and a connection component. The electrodes are arranged in a stack along a stacking dimension with a respective separator portion positioned between each of the electrodes. Each of the electrodes has an outer perimeter within a plane extending transverse to the stacking dimension, and the separator portions each have a respective overhanging portion protruding outwardly in a lateral dimension beyond the outer perimeters of adjacent ones of the electrodes, where the lateral dimension is oriented transverse to the stacking dimension. The connection component extends between and connects at least two adjacent overhanging portions of the separator portions. The connection component comprises a network of strands of material, a plurality of which cross over other strands so as to define respective crossing locations. A region of the connection component includes multiple crossing locations spaced apart from one another in the stacking dimension.

### CROSS-REFERENCE TO RELATED APPLICATIONS

This application claims priority from Korean Patent Application No. 10-2021-0127163 filed on Sep. 27, 2021 and from Korean Patent Application No. 10-2022-0114320 filed on Sep. 8, 2022, the entire disclosures of both which are hereby incorporated herein by reference.

### TECHNICAL FIELD

The present disclosure relates to an electrode assembly and a battery cell including the same, and more particularly, an electrode assembly that prevents the folding phenomenon of the separator, and a battery cell including the same.

### BACKGROUND

In modern society, as portable devices such as mobile phones, notebook computers, camcorders, and digital cameras have become used daily, the development of technologies in the fields related to such mobile devices has become active. In addition, chargeable/dischargeable secondary batteries are used as a power source for electric vehicles (EVs), hybrid electric vehicles (HEVs), plug-in hybrid electric vehicles (P-HEVs) and the like, in an attempt to solve air pollution and the like caused by existing gasoline vehicles that use fossil fuel. Therefore, there is a growing need for improvements to secondary batteries.

Currently commercialized secondary batteries include nickel cadmium batteries, nickel hydrogen batteries, nickel zinc batteries, and lithium secondary batteries. Among them, lithium secondary batteries have come into the spotlight because they have advantages, for example, hardly exhibiting memory effects compared to nickel-based secondary batteries and thus being freely charged and discharged, and having very low self-discharge rate and high energy density.

Secondary batteries may be classified based on the shape of their battery case into: a cylindrical battery having an electrode assembly mounted in a cylindrical metal can, a prismatic battery having an electrode assembly mounted in a prismatic metal can, and a pouch type battery having an electrode assembly mounted in a pouch-shaped case made of a laminated aluminum sheet.

Further, secondary batteries may be classified based on the structure of their electrode assembly, which has a structure in which a cathode and an anode are stacked with a separator being interposed between the cathode and the anode. Typically, the structural classifications include: a jelly-roll (wound) type structure and a stacked (laminated) type structure, or the like. In a jelly-roll (wound) type structure, a long sheet type cathode and a long sheet type anode are wound with a separator being interposed between the cathode and the anode. In a stacked (laminated) type structure, pluralities of cathodes and anodes cut into predetermined unit sizes are sequentially stacked with separators being interposed between the cathodes and the anodes. In recent years, in order to solve problems caused by the jelly-roll type electrode assembly and the stacked type electrode assembly, there has been developed a stacked/folded type electrode assembly, which is a combination of the jelly-roll type electrode assembly and the stacked type electrode assembly.

FIG. 1 is a side elevation view of a conventional electrode assembly. FIG. 2 is a photograph that has been taken of a portion of a side surface of a conventional electrode assembly. FIG. 3 is a diagram that illustrates a test related to the stiffness of a conventional electrode assembly.

Referring to FIG. 1, the electrode assembly is a stacked type electrode assembly, and it is formed by stacking unit cells in which a cathode 11, a separator 13, an anode 12, and a separator 13 are mainly stacked, or an anode 12, a cathode 11, and a separator 13 are sequentially stacked.

Meanwhile, since the separator 13 is usually formed larger than the cathode 11 or the anode 12, the end of the separator 13 in the electrode assembly projects outwardly of the cathode and anode, such that the projecting portion of the separator 13 is not adhered to the cathode 11 or the anode 12, which may lead to a problem in which the end of the separator 13 becomes bent or folded by an external force as in a region A of FIG. 2. Further, as shown in FIG. 3, when an uneven force is applied to the electrode assembly (e.g., under its own weight when the electrode assembly is supported only in its central region), the overall stiffness of the electrode assembly may be unacceptable, such that the electrode assembly is easily bent. In particular, this problem may occur more prominently on the long side of the separator 13 than on the short side.

### DETAILED DESCRIPTION OF THE INVENTION

### Technical Solution

The present invention provides, among other things, an electrode assembly and a battery cell comprising the electrode assembly. An electrode assembly in accordance with aspects of the invention includes a plurality of electrodes arranged in a stack along a stacking dimension with a respective separator portion positioned between each of the electrodes in the stack, and includes a connection component extending between and connecting a least two adjacent overhanging portions of the separator portions. Each of the electrodes in the stack preferably has an outer perimeter within a plane extending transverse to the stacking dimension. The separator portions may each have a respective overhanging portion protruding outwardly in a lateral dimension beyond the outer perimeters of adjacent electrodes, where such lateral dimension is oriented transverse to the stacking dimension. The connection component preferably comprises a network of strands of material, where some of the strands cross over other strands in the network so as to define respective crossing locations. Desirably, a region of the connection component includes multiple crossing locations spaced apart from one another in the stacking dimension.

In accordance with some aspects of the invention, the strands may have a width in a range from 20 µm to 100 µm.

In accordance with some aspects of the invention, the distance between adjacent strands in the network may be in a range from 100 µm to 800 µm.

In accordance with some aspects of the invention, the stack may have at least one lateral side extending parallel to the stacking dimension, where the connection component extends along that lateral side. In accordance with some of such aspects of the invention, the length dimension may be longer than the width dimension, both of which are orthogonal to the stacking dimension, and the lateral side extends along the length dimension of the stack. In accordance with some other of such aspects of the invention, the electrode assembly may include an electrode tab protruding outwardly from the stack, where the lateral side is oriented along the protruding direction of the electrode tab. In accordance with yet some other of such aspects of the invention, the connection component extends along the lateral side for a distance ranging from 70% to 80% of the length dimension thereof.

In accordance with some aspects of the invention, the separator portions are portions of an elongated separator sheet which is folded between each separator portion such that the elongated separator sheet follows a serpentine path traversing back and forth along the lateral dimension so as to extend between each of the successive electrodes in the stack. In accordance with some of such aspects of the invention, the electrode assembly may further include an outer separator encircling a perimeter of the stack and the connection component.

In accordance with some aspects of the invention, the connection component may be spaced away from contacting the electrodes.

In accordance with some aspects of the invention, the electrodes in the stack include at least one cathode and at least one anode, where the connection component is spaced away from contacting the cathode.

In accordance with some aspects of the invention, the connection component may have a thickness in the lateral dimension in a range from of 100 µm to 600 µm.

In accordance with some aspects of the invention, the connection component may extend between and connects more than two overhanging portions of the separator portions. In accordance with some of such aspects of the invention, the overhanging portions include an upper overhanging portion, a lower overhanging portion, and at least one intermediate overhanging portion therebetween. In accordance with such aspect, the connection component may extend continuously between the upper and lower overhanging portions such that the connection component extends around an outer edge of each of the intermediate overhanging portions, where the outer edge is an outermost extremity of the respective overhanging portion in the lateral dimension.

In accordance with some aspects of the invention, the strands of material of the connection component may comprise an adhesive material.

In accordance with some aspects of the invention, the strands of material comprising the network of strands of the connection component may follow circular arc-shaped paths crossing over one another. In accordance with some of such aspects of the invention, the circular arc-shaped paths may have diameters in a range between one half and one eighth of the height of the stack along the stacking dimension. In accordance with some other of such aspects of the invention, the circular arc-shaped paths may define a plurality of parallel, overlapping spirals. In accordance with such aspect, the overlapping spirals overlap by an amount in a range between one half and one eighth of a diameter of loops comprising the spirals. In accordance with yet some other of such aspects of the invention, the circular arc-shaped paths may define at least one spiral comprised of a plurality of loops, where each successive loop in the spiral overlaps a previous loop in the spiral by an amount in a range between one half and one eighth of a diameter of the loop.

### Advantageous Effects

As a result of embodiments according to the present invention, the electrode assembly of the present disclosure (and a battery cell including the same) include connection components extending between and connecting the overhanging portions of the separator portions, so as to improve rigidity of the overhanging portions. The connection components may be applied to opposing lateral sides of the electrode assembly.

The effects of the present disclosure are not limited to the effects mentioned above, and additional other effects not described above will be clearly understood by those skilled in the art from the below description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a side elevation view of a conventional electrode assembly;

FIG. 2 is a photograph that has been taken of a portion of a lateral side of a conventional electrode assembly;

FIG. 3 is a diagram that illustrates a test related to the stiffness of a conventional electrode assembly;

FIGS. 4 and 5 are side elevation views showing an electrode assembly according to respective embodiments of the present disclosure;

FIG. 6 is a photograph that has been taken of a portion of a lateral side of the electrode assembly;

FIG. 7 is a diagram that illustrates a test related to the stiffness of the electrode assembly;

FIG. 8 is a perspective view showing a portion of an exemplary device for applying an adhesive to the electrode assembly and a view of the adhesive as applied by such device;

FIG. 9 is a side elevation diagram illustrating another exemplary device for applying an adhesive to an electrode assembly and a view of another example of the adhesive as applied by such device;

FIG. 10 is a photograph comparing the adhesives applied using the devices of FIGS. 8 and 9;

FIG. 11 is an enlarged photograph of a region B of FIG. 10;

FIG. 12 are photographs of the results of a test related to the wettability of the electrode assembly to which the processes of FIGS. 8 and 9 had been applied; and

FIGS. 13 and 14 are side elevation views showing an electrode assembly according to another embodiment of the present disclosure.

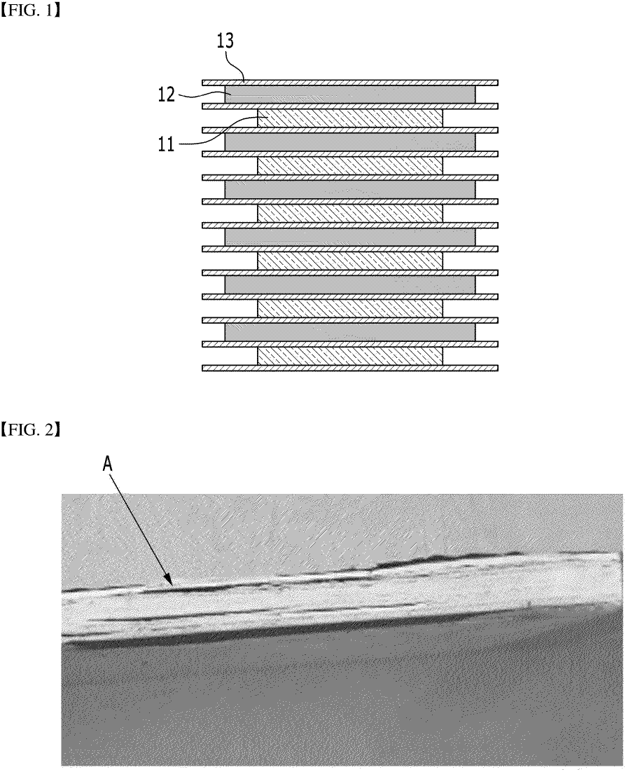

### DETAILED DESCRIPTION OF THE EMBODIMENTS

Hereinafter, various embodiments of the present disclosure will be described in detail with reference to the accompanying drawings so that those skilled in the art can carry them out. The present disclosure can be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element is arbitrarily illustrated for convenience of description, and the present disclosure is not necessarily limited to those illustrated in the drawings. In the drawings, the thicknesses of some layers, regions, etc. are exaggerated for clarity and/or convenience of description.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” includes disposed on or below a reference portion, and it does not necessarily mean being disposed on the upper end of the reference portion toward the opposite direction of gravity. The above qualifications likewise apply to cases where an element is described as being located “below” or “under” another part.

Further, throughout the description, when a portion is referred to as “including” or “comprising” a certain component, it means that the portion can further include other components, without excluding the other components, unless otherwise stated.

Further, throughout the description, when something is referred to as “cross-sectional” or a “cross section,” it refers to a target portion viewed from the side of a cross section cut vertically.

Hereinafter, a battery assembly according to an embodiment of the present disclosure will be described.

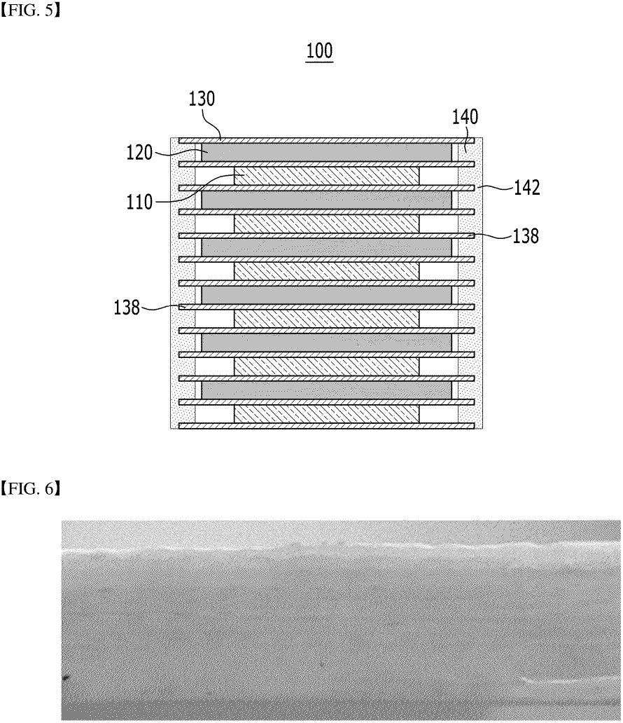

FIGS. 4 and 5 are side elevation views showing an electrode assembly according to respective embodiments of the present disclosure.

Referring to FIGS. 4 and 5, the electrode assembly 100 of the present embodiment is a power generation element capable of charging and discharging, which may include electrodes 110 and 120 and one or more separator portions 130. The separator portions 130 may be discrete from one another or the separator portions 130 may be portions of one or more larger separator sheets that have been folded back and forth so as to extend between successive electrodes (e.g., following a serpentine profile). The electrodes 110 and 120 included in the electrode assembly 100 may include a cathode 110 and an anode 120, and the separator portions 130 is interposed between the electrodes 110 and 120, so that the electrode assembly 100 has a structure in which cathode 110 / separator portion 130 / anode 120 are alternately stacked. The positions of the cathode 110 and the anode 120 shown in FIGS. 4 and 5 are shown for convenience, but the positions can be changed from each other.

Further, the electrode assembly 100 of the present embodiment may include one or more connection components 140 positioned along at least one lateral side of the cell stack, in which the electrodes 110 and 120 and the separator portions 130 are alternately stacked along a stacking dimension. Here, the cell stack refers to a stacked body of the electrodes 110 and 120 and the separator portions 130 in the electrode assembly 100, and may not include the connection components 140. Further, the lateral sides of the cell stack refer to the sides extending parallel to the stacking dimension where the ends of the plurality of electrodes 110 and 120 and/or the separator portions 130 in directions transverse to the stacking dimension are exposed. The at least one lateral side of the cell stack may include a side of the cell stack that extends along a longitudinal dimension of the electrode assembly 100 (i.e., the Z-axis direction of FIG. 4). When manufacturing the electrode assembly 100, the size of the separator portions 130 in at least one dimension transverse to the stacking dimension may be greater than the size of the electrodes 110 and 120 in that dimension, such that the edges of the separator portions 130 may protrude beyond the ends of the electrodes 110 and 120. In one example, with reference to the embodiment of FIG. 4, the separator portions 130 have a longer dimension than the electrodes 100 and 120 in the X-axis direction, such that the separator portions 130 include respective overhanging portions 138 protruding beyond the ends of the electrodes 110 and 120 in that direction.

Further, as discussed below, when the electrode assembly 100 is formed by zigzag stacking, the bent parts of the separator sheet comprising the various separator portions 130 may protrude beyond the ends of the electrodes 110 and 120.

The connection components 140 may be composed of an adhesive material, and the connection components 140 may be formed by applying the adhesive material along portions of at least one lateral side of the cell stack. The adhesive material may include a component that is not readily dissolved in the electrolytic solution. An example of the adhesive material used for the connection components 140 may include one or more of PO, PUR, EVA, and rubber series. Other examples may include curable adhesives capable of natural curing, moisture curing, UV curing, and the like.

The connection components 140 comes into contact with the overhanging portions 138 of adjacent separator portions 130, thereby helping to support the shapes of the separator portions 130. Such support provided by the connection components 140 may include providing rigidity to the overhanging portions 138.

Preferably, the connection components 140 do not come into contact with the cathode 110. This may be because the connection components 140 may disturb the flow of ions moving from the cathode 110 to the anode 120. Additionally, or alternatively, it is preferable that the connection components 140 do not come into contact with the anode 120. However, the anode 120 is not a direct charging region, and therefore any negative influence that may be caused by contact from the connection components 140 may be less with respect to the anode 120 than with respect to the cathode 110.

The connection components 140 may be positioned along all lateral sides of the cell stack of the electrode assembly 100. More preferably, the connection components 140 may be positioned along only some of the lateral sides. In that regard, when the connection components 140 are positioned along all of the lateral sides of the electrode assembly 100, the connection components 140 may impede the gas discharge of the electrode assembly 100 in the electrolytic solution impregnation or activation process of the electrodes 110 and 120.

The connection components 140 may be formed so as to cover the whole of one lateral side of the electrode assembly 100, or may be formed so as to cover an amount in a range from 70% to 80% of the lateral side. Such lateral side of the electrode assembly 100 may have a ‘height’ defined along the stacking dimension and a ‘length’ orthogonal to the height, which length corresponds to the length dimension of the long side or the short side of the electrode assembly 100. Thus, the connection components 140 may be formed so as to cover 70 to 80% of the length of the lateral side. By not covering the entire lateral side of the electrode assembly 100, such configuration of the connection components 140 may thereby avoid impeding the gas discharge of the electrode assembly 100 in the electrolytic solution impregnation or activation process of the electrodes 110 and 120.

The electrode assembly 100 may have a rectangular shape in a plane oriented orthogonal to the stacking dimension. Such rectangular shape may have a longer dimension and a shorter dimension. Preferably, the connection components 140 are positioned along the lateral sides corresponding to the longer dimension of the electrode assembly 100. This may be beneficial as it is believed that the folding phenomenon or the like may occur more frequently on the long side of the separator portions 130 having a relatively longer length than on the short side. However, the connection components 140 can also, or alternatively, be formed along one or more of the lateral sides corresponding to the shorter dimension of the electrode assembly 100.

As shown in FIG. 5, the connection components 140 may be joined together across multiple levels in the stacking direction by including portions 142 thereof that extend around the lateralmost outer edges of the separator portions 130.

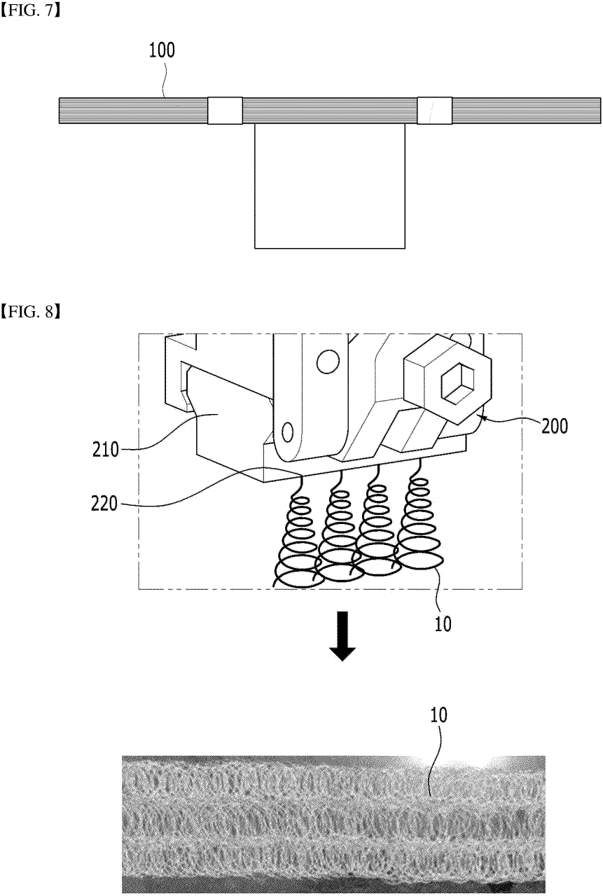

FIG. 6 is a photograph that has been taken of a portion of a lateral side of the electrode assembly. FIG. 7 is a diagram that illustrates a test related to the stiffness of the electrode assembly.

Referring to FIGS. 6 and 7, the connection components 140 can serve to resist a phenomenon in which the overhanging portions 138 of the separator 130 become folded. The connection components may also increase the stiffness of the electrode assembly 100.

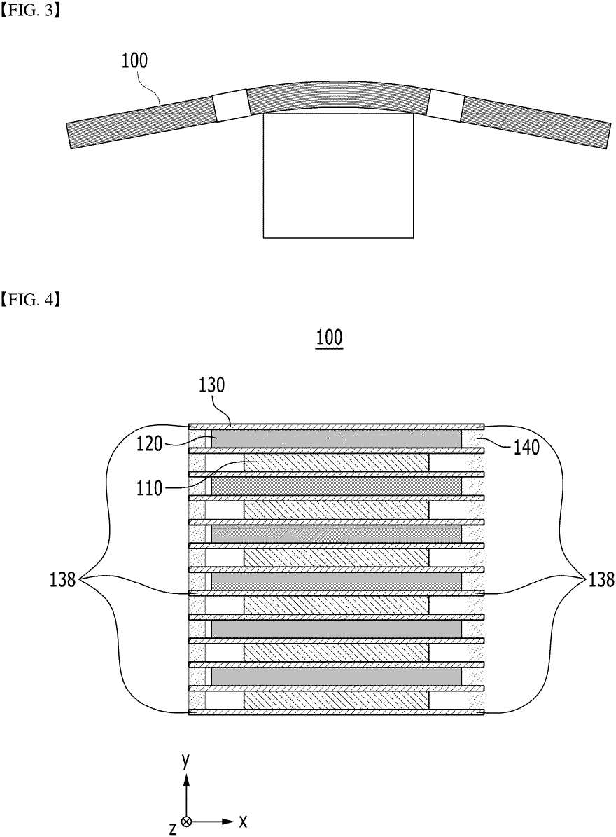

Specifically, it was found that when the connection components 140 are positioned along the lateral side of the electrode assembly 100, the folding phenomenon appearing in the region A of FIG. 2 described above is improved. Further, even in the same test as that performed in FIG. 3, it could be seen that the stiffness of the electrode assembly 100 was increased, and as a result, the electrode assembly 100 did not become bent does not occur. By supplementing the stiffness of the electrode assembly 100 in this way, it may be possible to prevent excessive deformation of the electrode assembly 100 when an external force is applied.

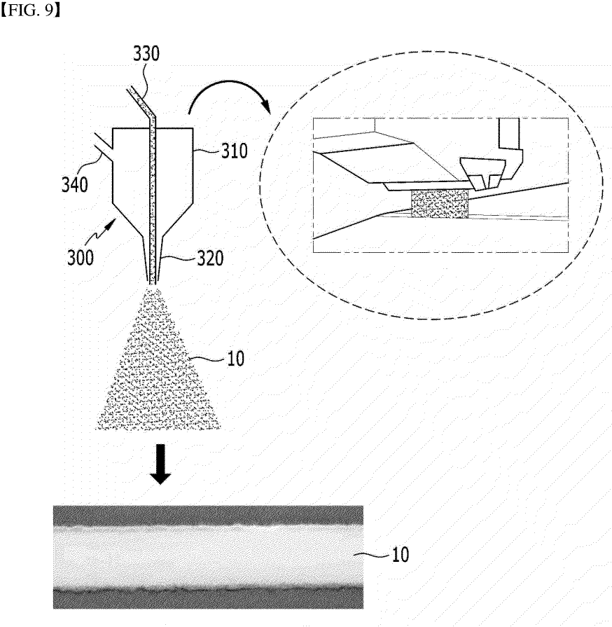

FIG. 8 is a perspective view showing a portion of an exemplary device for applying an adhesive to the electrode assembly to form the connection components 140, as well as a view of the adhesive as applied by such device. FIG. 9 is a side elevation diagram illustrating another exemplary device for applying an adhesive to an electrode assembly and a view of another example of the adhesive as applied by such device.

Referring to FIGS. 8, 10, and 11, the connection components 140 of the present embodiment may be defined by a network of strands 144 of the adhesive material, which network of strands may have a form similar to a net or web. The network of strands 144 include multiple nodes or crossing locations 146 where a strand 144 of adhesive material intersects or crosses over another strand 144 of material. Preferably, such nodes or crossing locations 146 involve the two strands 144 of adhesive material being connected together or joined at the crossing location 146. Although the present invention is not limited by any theory of operation, it is believed that increasing the quantity of nodes or crossing locations 146 in the network of strands 144 will beneficially increase the stiffness or bending strength of the connection components 140. This is believed to be somewhat analogous to, for example, a truss that produces stiffness and strength within an overall open structure by including a network of multiple two-force members or beams that are connected together at various nodes or joints. Thus, the resulting electrode assembly 100 here likewise desirably provides an open structure having a plurality of openings (between the various adjacent strands 144) that may desirably allow electrolytic solution and gas to readily move therethrough with minimal interference, as discussed below, while also providing stiffness and strength. Indeed, in formulating connection components 140 in accordance with the present embodiment, the network of strands 144 should be designed to optimize the conflicting goals of, on the one hand, increasing strand material (e.g., number and/or size of the strands 144) and number of nodes (in order to increase stiffness and strength), versus, on the other hand, increasing the amount of open space through the connection components 140 between the strands 144 (in order to increase wettability of the electrode assembly 100 by the electrolytic solution).

The network of strands 144 of the adhesive material may be formed by a patterning method. Here, the patterning method may mean applying an adhesive so that the adhesive 10 applied to the target position has a predetermined pattern.

The adhesive application device 200 based on the patterning method may include a housing 210 and one or more nozzles 220. The adhesive 10 may be supplied from the outside of the device 200 and housed in the housing 210, and the adhesive 10 that has passed through each nozzle 220 can be discharged in the form of a line so as to form a linear strand 144. The applied adhesive 10 may have a specific pattern according to the movement of the nozzle(s) 220. As an example, the housing 210 may move in a spiral pattern while discharging the adhesive 10, thus resulting in a pattern defined by a large number of overlapping circular shapes.

In another example (not shown), the housing 210 may be structured such that each of the nozzles 220 have independently-controllable directionality. As a result, the device 200 may control the application of the strands 144 from each nozzle 220 (e.g., by controlling which strands 144 are deposited below or above others), such that the resulting network of strands is more like a woven pattern.

The network of strands 144 can be formed in patterns other than spiral patterns, as long as such patterns involve the strands intersecting at multiple nodes. Preferably such patterns involve multiple nodes spaced apart from one another in the stacking dimension of the electrode stack. As an example, such pattern may be or include a diagonal lattice, where a first set of multiple, generally parallel linear strands of adhesive material extend along an oblique angle across a lateral side of the stack, and a second set of generally parallel linear strands of the adhesive material that extend across the lateral side at a different oblique angle, such that multiple nodes are created where the strands of the first set cross over the strands of the second set.

Referring to FIG. 9, the connection components 140 may be formed by a surface application method. Here, the surface application method may mean applying an adhesive with a high density so that the adhesive 10 is applied to the target location without gaps.

The adhesive application device 300 based on such surface application method can apply the adhesive 10 so that the adhesive 10 covers the whole of the target portion as shown in the photograph of FIG. 9. The adhesive application device 300 can apply the adhesive through a spray, slot, or other method. In one example, the adhesive application device 300 may include a housing 310, a nozzle 320, and a tube 330 through which the adhesive 10 is supplied into the housing 310, and an air tube 340 for injecting compressed air when the adhesive 10 is sprayed through the nozzle 320 connected to the tube 330.

Meanwhile, since the adhesive application device 300 of FIG. 9 uses a compressed air, or the like, a scattering phenomenon of the adhesive 10 may occur at the time of spraying the adhesive 10. Further, the surface application method of the adhesive application device 300 of FIG. 9 may result in higher thickness of the connection components 140 than result from the device 200 of FIG. 8, which could disadvantageously lead to lower uniformity of the applied connection components 140.

On the other hand, since the adhesive application device 200 of FIG. 8 discharges the adhesive 10 in the form of a line, any scattering phenomenon of the adhesive in the air or the like may be minimized, and the contamination of the device may also be minimized. Further, the device 200 of FIG. 8 may be configured to adjust the distance between the applied strands 144 so that the density and thickness of the resulting connection components 140 can be relatively freely adjusted. The device 200 of FIG. 8 also applies the adhesive 10 in a certain pattern, which may also result in the adhesive 10 being applied more uniformly than that applied by the adhesive application device 300 of FIG. 9, even when the adhesive 10 is adjusted so as to be applied thick.

The device 200 of FIG. 8 may be able to more easily minimize the thickness of the connection components 140 as compared with the device 300 of FIG. 9. Specifically, the thickness of the connection components 140 formed by the device 200 of FIG. 8 may be about 100 µm or more, whereas the thickness of the connection components 140 formed by the device 300 of FIG. 9 may be about 200 µmor more. This may be because of the ability of the device 200 of FIG. 8 to apply the adhesive 10 in the form of lines, as described above.

The thickness of the adhesive member 140 formed on the electrode assembly 100 can be variously set according. For example, considering the size of the space between the electrode assembly 100 and the battery case in the battery cell, the thickness of the adhesive member 140 can be designed to be less than or equal to that size. As a specific example, when the electrode assembly 100 is incorporated in the battery case in a state where the connection components 140 are not formed, the separation distance between the electrode assembly 100 and the battery case may be about 600 µm.In this case, the thickness of the connection components 140 positioned along the electrode assembly 100 may be 600 µmor less, 500 µmor less, 400 µmor less, 300 µmor less, or 200 µmor less. Further, the thickness of the connection components 140 positioned along the electrode assembly 100 may be 100 to 600 µm, 100 to 500 µm, 100 to 400 µm, 100 to 300 µm, or 100 to 200 µm.

The adhesive 10 may be provided through the adhesive application device at a predetermined temperature. For example, the adhesive application device may adjust the temperature of the adhesive 10 so that the adhesive 10 can be easily applied. The operating temperature of the device 200 of FIG. 8 may be 110° C., and the temperature of the adhesive 10 discharged from the device 200 may be in a range from 40° C. to 50° C. The operating temperature of the device 300 of FIG. 9 may be 160° C., and the temperature of the adhesive 10 discharged from the device 200 may be in a range from 60° C. to 70° C. If the temperature of the adhesive 10 is too high, the separator portions 130 may be likely to contract. Therefore, it may be preferable to use the device 200 of FIG. 8 rather than the device 300 of FIG. 9 to form the connection components 140 of the present invention.

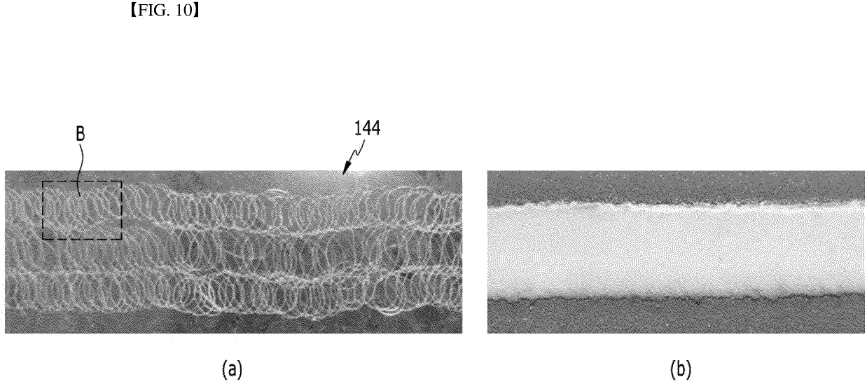

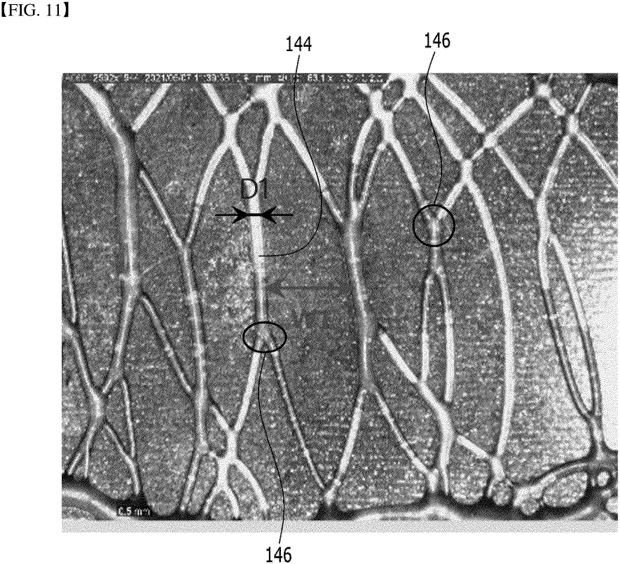

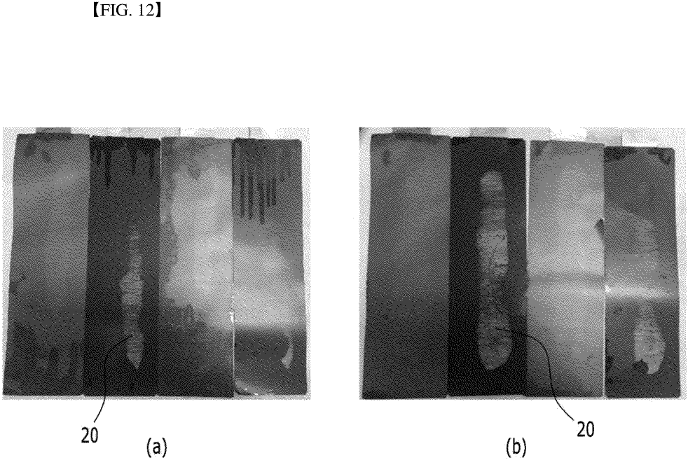

FIG. 10 is a photograph comparing the adhesives applied using the devices of FIGS. 8 and 9. FIG. 11 is an enlarged photograph of a region B of FIG. 10.

Referring to FIGS. 10 and 11, the application patterns of the adhesive according to the devices of FIGS. 8 and 9 can be compared.

FIG. 10(a) is based on a patterning method, and may be formed by the device 200 of FIG. 8. In FIG. 10(a), the adhesive 10 was discharged from the housing 210 in linear strands 144 while the housing 210 was repeatedly moved to follow a spiral shape or a circular shape. The resulting network of strands 144 may define a pattern in which multiple strands 144 intersect or cross over one another. The resulting network comprising the connection components 140 may include a plurality of openings (between the various adjacent strands 144). In preferred embodiments, the width of strands 144 of adhesive 10 be in a range from 20 µm to 100 µm, and the distances between the adjacent strands 144 may be in a range from 100 µm to 800 µm.For example, referring to FIG. 11, the width d1 of the strands 144 is 50 µm, and the distance w1 between adjacent strands 144 in the pattern is 600 µm.In some preferred embodiments of connection components 140 formed by patterning methods in accordance with the present invention, the pattern may result in a ratio of material to open space in a range from 1:40 to 1:1. For example, a preferred embodiment may have a ratio of about 1:12.

Other parameters of the spiral patterning method of FIG. 10(a) may be adjusted in order to optimize the conflicting goals of increasing stiffness versus increasing open regions through the connection components 140 so as to increase wettability by the electrolytic solution. For example, in forming a spiral pattern of overlapping circular shapes, among the parameters than can be adjusted are: the sizes (e.g., diameters) of the circles; the linear distance that the pattern advances for each loop of the spiral (which relates to the amount of overlap between successive loops of the spiral); and the amount of overlap between adjacent, parallel rows of loops defined along the length of the pattern. In some examples, the diameter of the circular loops may be no more than half the height of the stack along the stacking dimension. In that way, at least two parallel, overlapping rows of loops may be defined along the length of the pattern. In other embodiments, the diameter of the circular loops may be about one quarter of the height of the stack, such that four parallel, overlapping rows of loops are defined along the length of the pattern. In some embodiments, the diameters of the circular loops may be in a range between one quarter (¼) and one half (½) of the height of the stack along the stacking dimension.

With regard to the linear distance that the pattern advances for each loop of the spiral, in some embodiments the amount of such linear advancement may be related to the diameter of the loops. For example, the pattern may advance linearly no more than one half (½) of the diameter of the loop between successive loops, which may provide a sufficient amount of overlap between loops (and thus a sufficient amount of resulting crossing nodes). In a specific embodiment, the pattern may advance linearly by about one quarter (¼) of the diameter of the loop between successive loops in the pattern, and in another embodiment the pattern may advance linearly by about one eighth (⅛) of the diameter of the loop between successive loops in the pattern. In other embodiments, the pattern may advance linearly by an amount in a range between one half (½) and one eighth (⅛) of the diameter of the loops.

As to the amount of overlap between adjacent, parallel rows of loops defined along the length of the pattern, in some embodiments the amount of such overlap may also be related to the diameters of the loops. For example, in some embodiments, the adjacent, parallel rows of loops may overlap by about one half (½) of the diameter of the loops. In other embodiments, the adjacent, parallel rows of loops may overlap by about one quarter (¼) of the diameter of the loops. In yet other embodiments, the adjacent, parallel rows of loops may overlap by about one eighth (⅛) of the diameter of the loops. In some embodiments, the adjacent parallel rows of loops may overlap by an amount in a range from one half (½) to one eighth (⅛) of the diameter of the loops.

Meanwhile, FIG. 10(b) is based on a surface application method, and may be formed by the device 300 of FIG. 9. In FIG. 10(b), there may be no gaps or openings between regions of the adhesive 10, such that the connection component 144 is essentially a single continuous surface.

Since the connection components 140 are formed on the lateral side of the electrode assembly 100, the connection components 140 could impair the electrolytic solution absorbed through the lateral side of the electrode assembly 100 from coming into contact with the electrodes 110 and 120. Therefore, it is desirable that the connection components 140 be formed to minimize any decrease in absorption of the electrolytic solution.

FIG. 12 are photographs of the results of a test related to the wettability of the electrode assembly to which the processes of FIGS. 8 and 9 had been applied. Specifically, FIGS. 12(a) and 12(b) were obtained by taking the electrode assemblies 100 having the connection components 140 formed through the processes of FIGS. 8 and 9, respectively, and impregnating them with electrolytic solution, followed by disassembling. Regions in which the electrolytic solution was not absorbed in the electrodes 110 and 120 are designated as non-wetting regions 20 in the photographs.

Referring to FIG. 12, the electrodes 110 and 120 of FIG. 12(a) to which the patterning method of FIG. 8 was applied have a smaller non-wetting region 20 than the electrodes 110 and 120 of FIG. 12(b) to which the surface application method of FIG. 9 was applied. In other words, the connection components 140 of FIG. 8 may interfere less with the absorption of the electrolytic solution than the connection components 140 of FIG. 9.

Since the pattern application method of FIG. 8 has a pattern in which a plurality of linear strands 144 intersect, it may be formed so as to define a plurality of openings through the connection components 140. Thus, when the electrode assembly 100 is impregnated with electrolytic solution, the electrolytic solution can be readily absorbed into the inside of the electrode assembly 100 through such openings without much or any interference from the connection components 140, as compared with the surface application method of FIG. 9. If the electrolytic solution is not well absorbed by the electrodes 110 and 120, the output characteristics of the electrode assembly 100 can be deteriorated. Therefore, when the connection components 140 are formed by the surface application method of FIG. 9, the absorption rate of the electrolytic solution can be increased by forming the adhesive member 140 over only a portion of the lateral side of the electrode assembly 100. On the other hand, forming the adhesive member 140 over only a portion of the lateral side of the electrode assembly can lead to lower stiffness of the electrode assembly 100. Thus, when using the surface application method of FIG. 9, the position(s) and amounts of applied connection components 140 may have to be controlled accordingly. Indeed, in any method of positioning connection components 140 along one or more lateral sides of the electrode assembly in accordance with the present invention, the applied connection components 140 should be designed to optimize the conflicting considerations of stiffness of the resulting electrode assembly 100 versus wettability of the electrode assembly 100 by the electrolytic solution.

Next, an electrode assembly according to another embodiment of the present disclosure will be described.

Prior to the description, it should be clarified that the electrode assembly of the present embodiment is generally the same as the above-mentioned electrode assemblies, except that the shape of the cell stack is different. Therefore, unless otherwise stated, the electrode assembly according to the present embodiment may be assumed to include all the contents related to the electrode assemblies of FIGS. 4 to 12 described above.

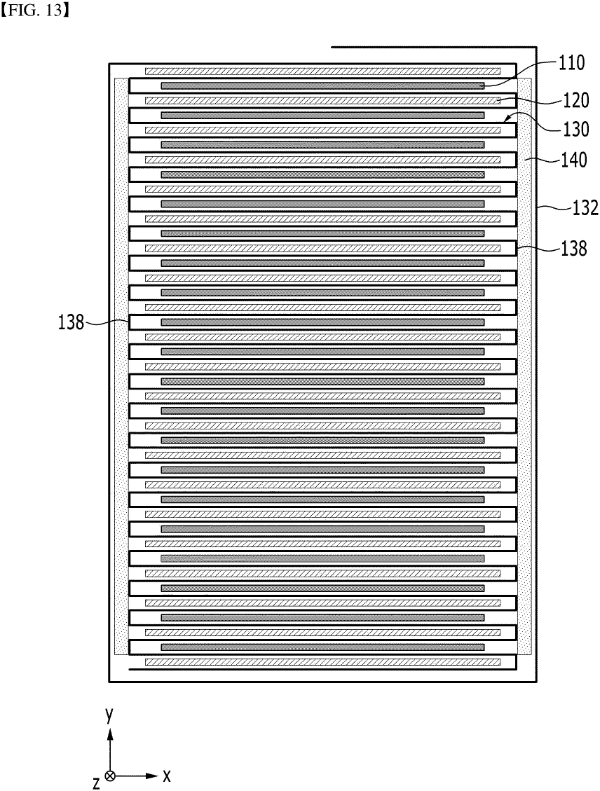

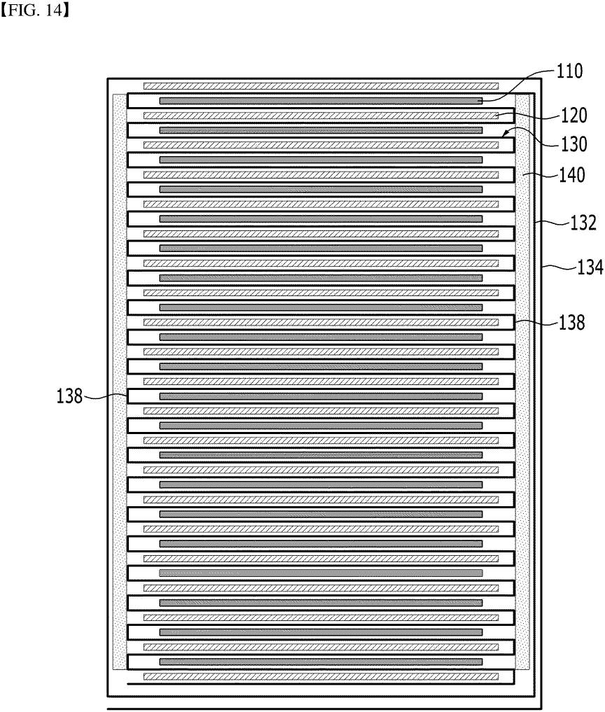

FIGS. 13 and 14 are side elevation views showing an electrode assembly according to another embodiment of the present disclosure.

Referring to FIGS. 13 and 14, the electrode assembly 100 of the present embodiment may include a cell stack in which cathode 110 / separator portion 130 / anode 120 are alternately stacked, and finishing separators 132 and 134 wrap around the outer perimeter of the cell stack.

Here, the separator portions 130 may be portions of an elongated separator sheet which repeatedly traverses back and forth between successive electrodes (cathode 110 and anode 120) in the stack, the separator sheet wrapping around an edge of each successive electrode at a respective folded part 138 of the separator sheet, so as to follow a zigzag or serpentine path through the cell stack. After such zigzag stacking is completed, the separator sheet can wrap around a perimeter of the cell stack at least once, thereby defining outer separators 132 and 134 that cover the lateral sides of the stack. The positions of the cathode 110 and the anode 120 shown in FIGS. 13 and 14 are shown for convenience, but the positions can be changed from each other.

The connection components 140 can be formed along a lateral side of the cell stack. In particular, as shown in FIGS. 13 and 14, the connection components 140 can be positioned in contact with the folded parts 138 of the separator sheet, so as to help fix the shape of the separator sheet.

The connection components 140 may be positioned along all lateral sides of the cell stack, as described above, but in another configuration they can be positioned on both opposing lateral sides where the folded parts 138 of the separator sheet are located. In another alternative, unlike FIGS. 13 and 14, the connection components can be formed on another side of the cell stack. However, as discussed above, the position of the connection components 140 needs to be properly designed in order to avoid excessively disturbing the process of impregnating or activating the electrodes 110 and 120 with an electrolytic solution. For example, the connection components 140 may be formed so as to cover the whole of one lateral side of the electrode assembly 100, or they may be formed so as to cover 70 to 80% of the side surface of the electrode assembly 100.

After the connection components 140 are positioned on the cell stack, the outer separators 132 and 134 may be positioned along the outside of the connection components 140. That is, the outer separators 132 and 134 may wrap around the lateral sides on which the connection components 140 are formed. The outer separator 132 may be formed by surrounding the outer perimeter of the cell stack once, as shown in FIG. 13. In another, the outer separators 132 and 134 wrap twice around the cell stack, as shown in FIG. 14.

Alternatively, without providing the outer separators 132 and 134 in the electrode assembly 100, the lateral side(s) of the cell stack can be finished by attaching an adhesive means such as heat sealing or adhesive tape, and the finishing method may be implemented in various ways in addition to the above-mentioned embodiments.

Next, a method of manufacturing an electrode assembly according to an embodiment of the present disclosure will be described.

The manufacturing method (S1000) of the electrode assembly of the present embodiment may include a step of forming a cell stack in which the electrodes 110 and 120 and the separator portions 130 are alternately stacked (S1100), then a step of applying the adhesive 10 to a lateral side of the cell stack (S1200), and a step of forming the connection components 140 for providing rigidity to the separator portions 130 (S1300).

With respect to the step of forming the cell stack (S1100), any known method can be used, as long as the electrodes and the separator portions are stacked in the order of: cathode 110, separator portion 130, anode 120, and separator portion 130; or in the order of: anode 120, separator portion 130, cathode 110, and separator portion 130. For example, the cell stack can be manufactured in a stacked type as shown in FIGS. 4 and 5, or it may be manufactured in a zig-zag shape as shown in FIGS. 13 and 14.

With regard to the step of applying the adhesive to the side surface of the cell stack (S1200), the device 200 of FIG. 8 can be used, or the application device 300 of FIG. 9 can be used. When the device 200 of FIG. 8 is used, the step (S1200) may include a step of determining the application pattern of the adhesive 10 and/or a step of moving the nozzle 220 according to the determined pattern in order to apply the adhesive in the pattern. The step of determining the application pattern of the adhesive 10 may be performed before the step of forming the cell stack (S1100).

Since the adhesive 10 is applied in a viscous state, it may be desirable to allow the shape of the adhesive 10 to be fixed by removing the solvent or moisture in the adhesive. In such case, the step of forming the connection components 140 (S1300) may include a step of drying the adhesive 10. Additionally or alternatively, depending on the nature of the adhesive 10, the adhesive 10 can be solidified by heat curing or UV curing, and, in such a case, the step of forming the connection components 140 (S1300) may include a step of curing the adhesive 10.

On the other hand, when the present embodiment involves a method of manufacturing the zigzag type electrode assembly 100 shown in FIGS. 13 and 14, the above-mentioned method may further include a step of finishing the lateral sides of the cell stack (S1400). In that step, the outer separators 132 and 134 may be applied around the outer perimeter of the cell stack. The outer separators 132 and 134 may be completed after wrapping around the perimeter of the cell stack at least once. That is, the outer separators 132 and 134 may wrap around the cell stack once, as shown in FIG. 13, or the cell stack may be wrapped twice or more, as shown inf FIG. 14.

Further, the method of manufacturing the electrode assembly 100 according to the present embodiment may further include, after the application of the outer separators 132 and 134, a step of pressing the outer separators 132 and 134 along a direction (e.g., X-axis direction) inwardly towards the lateral side of the cell stack.

When such steps are added, the outer separators 132 and 134 and the connection components 140 are preferably adhered to each other, so that the overall stiffness of the electrode assembly is improved. In addition, the outer separators 132 and 134 may have the beneficial effect of more strongly winding the electrode assembly. Accordingly, the overall result is desirably to resist bending of the battery cell.

The electrode assembly 100 of the present embodiment described above may be housed in a cell case together with an electrolytic solution in order to produce a battery cell.

A battery cell according to an embodiment of the present invention may include an electrode assembly 100 in which a plurality of electrodes and a plurality of separator portions are alternately stacked, electrode leads connected to electrode tabs extending from a plurality of the electrodes, and a cell case for sealing the electrode assembly in a state where one end of the electrode leads protrude.

The above-mentioned battery cell can be stacked with others along a direction to form a battery cell stack, and the battery cell stack can be integrated together with a battery management system (BMS) and/or a cooling device that is modularized into a battery module and manages the temperature or voltage of the battery. The battery pack can be applied to various devices. For example, a device to which the battery pack may be applied may be a vehicle such as an electric bicycle, an electric vehicle, or a hybrid vehicle, but the present disclosure is not limited thereto. The battery pack according to the present embodiment can be used for various devices in addition to the above examples, which also falls within the scope of the present disclosure.

Although preferred embodiments of the present disclosure have been described in detail above, the scope of the present disclosure is not limited thereto. Within the scope of the present disclosure, various modifications and improvements made by those skilled in the art using the basic concepts of the present disclosure, which are defined in the appended claims.

### DESCRIPTION OF REFERENCE NUMERALS

10: adhesive
100: electrode assembly
110: cathode
120: anode
130: separator portion
132: outer separator
134: outer separator
138: overhanging portion
140: connection component
142: portion
144: strand
146: crossing location
200: adhesive application device
210: housing
220: nozzle
300: adhesive application device
310: housing
320: nozzle
330: tube
340: air tube

1. An electrode assembly, comprising:
a plurality of electrodes arranged in a stack along a stacking dimension with a respective separator portion positioned between each of the electrodes in the stack, each of the electrodes having an outer perimeter within a plane extending transverse to the stacking dimension, wherein the separator portions each have a respective overhanging portion protruding outwardly in a lateral dimension beyond the outer perimeters of adjacent ones of the electrodes, the lateral dimension being oriented transverse to the stacking dimension; and
a connection component extending between and connecting at least two adjacent overhanging portions of the separator portions, the connection component comprising a network of strands of material, a plurality of the strands of material crossing over other ones of the strands of material so as to define respective crossing locations, wherein a region of the connection component includes multiple crossing locations spaced apart from one another in the stacking dimension.

2. The electrode assembly of claim 1, wherein the strands have a width in a range from 20 µm to 100 µm.

3. The electrode assembly of claim 1, wherein a distance between adjacent strands is in a range from 100 µm to 800 µm.

4. The electrode assembly of claim 1, wherein the stack has at least one lateral side extending parallel to the stacking dimension, and wherein the connection component extends along the at least one lateral side.

5. The electrode assembly of claim 4, wherein the stack has a length dimension and a width dimension extending orthogonally to one another, both the length dimension and the width dimension extending orthogonally to the stacking dimension, and the length dimension being longer than the width dimension, wherein the at least one lateral side extends along the length dimension of the stack.

6. The electrode assembly of claim 4, further comprising an electrode tab protruding outwardly from the stack along a protruding direction transverse to the stacking dimension, wherein the at least one lateral side is oriented along the protruding direction.

7. The electrode assembly of claim 4, wherein the at least one lateral side has a length dimension along a direction oriented orthogonally to the stacking dimension, and wherein the connection component extends along the at least one lateral side for a distance ranging from 70% to 80% of the length dimension thereof.

8. The electrode assembly of claim 1, wherein the separator portions are portions of an elongated separator sheet, the elongated separator sheet being folded between each separator portion such that the elongated separator sheet follows a serpentine path traversing back and forth along the lateral dimension to extend between each of the successive electrodes in the stack.

9. The electrode assembly of claim 8, further including an outer separator encircling a perimeter of the stack and the connection component.

10. The electrode assembly of claim 1, wherein the connection component is spaced away from contacting the plurality of electrodes.

11. The electrode assembly of claim 1, wherein the plurality of electrodes include a cathode and an anode, and wherein the connection component is spaced away from contacting the cathode.

12. The electrode assembly of claim 1, wherein the connection component has a thickness in the lateral dimension in a range from of 100 µm to 600 µm.

13. The electrode assembly of claim 1, wherein the connection component extends between and connects more than two overhanging portions of the separator portions.

14. The electrode assembly of claim 13, wherein the more than two overhanging portions include an upper overhanging portion, a lower overhanging portion, and at least one intermediate overhanging portion therebetween, and wherein the connection component extends continuously between the upper and lower overhanging portions such that the connection component extends around an outer edge of each of the at least one intermediate overhanging portion, the outer edge being an outermost extremity of the respective overhanging portion in the lateral dimension.

15. The electrode assembly of claim 1, wherein the strands of material of the connection component comprise an adhesive material.

16. The electrode assembly of claim 1, wherein the strands of material comprising the network of strands of the connection component follow circular arc-shaped paths crossing over one another.

17. The electrode assembly of claim 16, wherein the circular arc-shaped paths have diameters in a range between one half and one eighth of a height of the stack along the stacking dimension.

18. The electrode assembly of claim 16, wherein the circular arc-shaped paths define a plurality of parallel, overlapping spirals, and wherein the overlapping spirals overlap by an amount in a range between one half and one eighth of a diameter of loops comprising the spirals.

19. The electrode assembly of claim 16, wherein the circular arc-shaped paths define at least one spiral comprised of a plurality of loops, and wherein each successive loop in the spiral overlaps a previous loop in the spiral by an amount in a range between one half and one eighth of a diameter of the loop.

20. A battery cell comprising the electrode assembly of claim 1.
